(19) United States
(12) Patent Application Publication
(10) Pub. No.: US 2026/0038322 A1
(43) Pub. Date: Feb. 5, 2026

(54) METHODS AND APPARATUS TO IMPLEMENT A HETEROGENEOUS QUORUM-BASED SYSTEM

(71) Applicant: Cloudera, Inc., Santa Clara, CA (US)

(72) Inventors: Uma Maheswara Rao Gangumalla, Milpitas, CA (US); Prashant Pogde, Sunnyvale, CA (US); Siddharth Jivan Wagle, Saratoga, CA (US); Tsz Wo Sze, San Jose, CA (US)

(21) Appl. No.: 18/788,454

(22) Filed: Jul. 30, 2024

(51) Int. Cl. G07C 13/00

(52) U.S. Cl. CPC G07C 13/00

(57) ABSTRACT

Disclosed examples cause transmission of an advertisement from a first node in a first availability zone to a second node in a second availability zone and a third node in a third availability zone, the advertisement to specify a leader-candidate status for the first node, the first node and the second node eligible to vote for a leader and eligible to serve as a leader node, the third node eligible to vote for the leader and ineligible to serve as the leader node; access votes from the second node in the second availability zone and the third node in the third availability zone; and after the votes satisfy a quorum to elect the first node as the leader node, set a role of the first node as the leader node.

### FIELD OF THE DISCLOSURE

This disclosure relates generally to data center storage systems and, more particularly, to methods and apparatus to implement a heterogenous quorum-based system.

### BACKGROUND

Computer storage systems store information in storage devices. Some storage systems use quorum-based writes for their metadata servers to provide consistency and durability guarantees. For a quorum-based write to occur, a quorum depends on a majority commitment from participating nodes. For example, in a storage system having five nodes, a majority vote results when at least three of the five nodes vote in the affirmative.

### BRIEF DESCRIPTION OF THE DRAWINGS

FIG. 1 is a block diagram of an example consistent and heterogeneous quorum-based system that operates to provide consistent and highly available storage distributed across multiple locations.

FIG. 2 shows a scenario of the example consistent and heterogeneous quorum-based system of FIG. 1 in which a primary-tier node in a first data center becomes unavailable.

FIG. 3 shows another scenario of the example consistent and heterogeneous quorum-based system of FIG. 1 in which a primary-tier node in a second data center becomes unavailable.

FIG. 4 is a block diagram of another example consistent and heterogeneous quorum-based system implemented in accordance with examples disclosed herein to provide consistent and highly available storage using multiple availability zones per data center.

FIG. 5A is a block diagram of another example consistent and heterogeneous quorum-based system implemented in accordance with examples disclosed herein to provide consistent and highly available storage distributed across multiple locations.

FIG. 5B is a block diagram of yet another example consistent and heterogeneous quorum-based system implemented in accordance with examples disclosed herein to provide consistent and highly available storage distributed across multiple locations.

FIG. 6 is a block diagram of an example implementation of a node controller that may be used to implement node controllers of FIGS. 1-4, 5A, and 5B.

FIG. 7 is a flowchart representative of example machine-readable instructions and/or example operations that may be executed, instantiated, and/or performed by example programmable circuitry to implement the node controller 600 of FIG. 6 to set a leader role for a corresponding node.

FIG. 8 is a flowchart representative of example machine-readable instructions and/or example operations that may be executed, instantiated, and/or performed by example programmable circuitry to implement the node controller 600 of FIG. 6 to set a follower role for a corresponding node and change to a leader role upon failure of a leader node.

FIG. 9 is a block diagram of an example processing platform including programmable circuitry structured to execute, instantiate, and/or perform the example machine-readable instructions and/or perform the example operations of FIGS. 7 and 8 to implement the node controller 600 of FIG. 6.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine-readable instructions of FIGS. 7 and 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Data center storage systems can be used to implement off-site data storage solutions. Data center (DC) storage systems based on two data centers (e.g., two-DC storage systems) can be used for disaster recovery by providing redundancy for stored data between the first data center and the second data center. A majority of distributed storage systems use quorum-based writes for their metadata servers so that consistency and durability guarantees can be made. Achieving a quorum for such writes with two data centers is not possible because a quorum depends on a majority commitment from the participating nodes. As such, split-brain scenarios (e.g., indecisive systems) are a major problem with two-DC setups. An odd number of nodes across data centers is needed to achieve quorum with a majority of votes (N/2+1, where N>1). This means a two-DC storage system that hosts an even number of nodes needs an additional DC to achieve quorum. This increases operational costs related to setting up a high-speed low-latency network and provisioning constraints. As such, cost savings can be a driving factor for preferring a two-DC setup instead of a three-DC setup.

Examples disclosed herein may be used to build a substantially consistent and heterogeneous quorum-based system. Such a system may be implemented using a heterogenous consensus-based distributed stretch cluster that can span over multiple availability zones or data centers. As used herein, a consistent system is a system in which every read operation of a data location accesses the data most recently written to that data location or results in an error. In this manner, a read operation does not return an old or outdated read result. As used herein, a heterogeneous system is a system of multiple participants (or nodes) in a cluster in which the participants are provisioned across multiple networks and at least one of those networks has a different latency and bandwidth (e.g., guaranteed latency and bandwidth) than the other network(s) in the cluster. In examples disclosed herein, the terms participant and node are used interchangeably.

Examples of substantially consistent and heterogeneous quorum-based system disclosed herein are based on an odd number of participants connected in a cluster. Each participant or node in a cluster is provisioned in a respective availability zone. As used herein, an availability zone is a failure-isolated physical compute space (e.g., a failure domain) that is isolated from being affected by failures in other availability zones and isolated from its failures affecting other availability zones. Separating participants or nodes across respective availability zones and replicating information between those nodes increases availabilities of services (e.g., storage services) provided by those nodes. That is, if one availability zone sustains a catastrophic event leading to node failure, replicated nodes in other availability zones can maintain operability of a hosted service.

A DC can host a single availability zone or multiple availability zones. For example, a single DC can host multiple availability zones by providing multiple isolated power domains such that failure of one power domain does not affect power delivery of other power domains. In this manner, availability zones located on different power domains implement a failure-recovery environment in the data center. As such, substantially consistent and heterogeneous quorum-based systems can be implemented in accordance with examples disclosed herein using an odd number or an even number of data centers.

In some examples, participants or nodes in respective availability zones could be geographically far apart enough so that a single stretch cluster can tolerate both local failures and an entire data center failure due to, for example, natural disasters. Such implementations can be used to offer inbuilt disaster recovery. In some examples, a stretch cluster can include a combination of nodes spread across private data centers and public clouds while satisfying security and privacy requirements of provided services (e.g., storage services). In such examples, a public cloud may communicate in the stretch cluster via a slower network connection than a network connection used by the data centers. However, in examples disclosed herein, service quality is not degraded or impacted negatively even when a stretch cluster includes a slower participant in the public cloud.

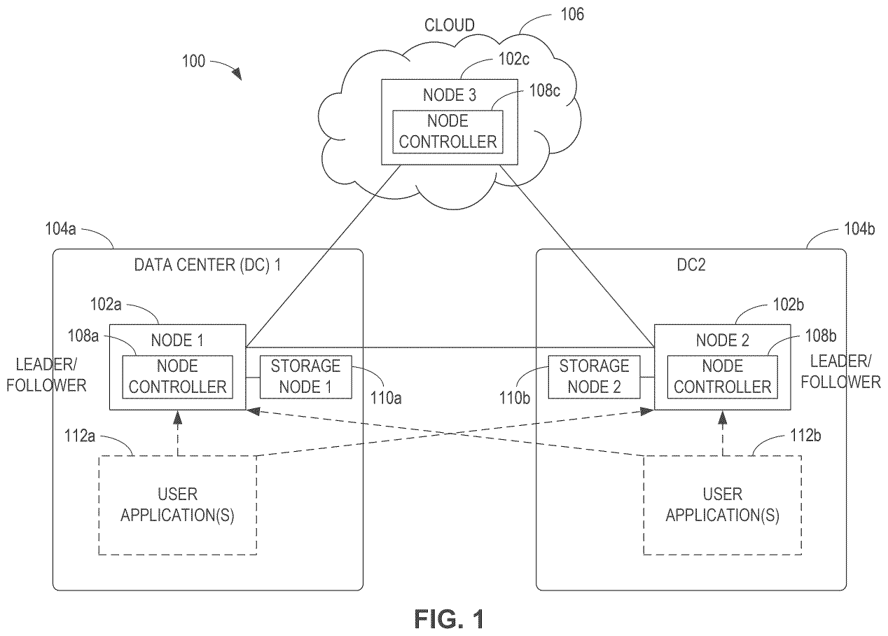

FIG. 1 is a block diagram of an example consistent and heterogeneous quorum-based system 100 (e.g., the quorum-based system 100) that operates to provide consistent and highly available storage distributed across multiple locations. Examples of consistent and heterogeneous quorum systems disclosed herein include an odd number of participants. For purposes of simplicity, the consistent and heterogeneous quorum-based system 100 of FIG. 1 is shown as including three participants. However, examples disclosed herein may be implemented using any other odd number of participants.

The quorum-based system 100 is a multi-DC storage system that includes three participants identified as an example first primary-tier node 102a, an example second primary-tier node 102b, and an example secondary-tier node 102c. The nodes 102a-c are connected to one another to form a stretch cluster. In examples disclosed herein, only two of the participants (e.g., the first primary-tier node 102a and the second primary-tier node 102b) need to be connected via a low-latency, high-bandwidth network. As used herein, a low-latency, high-bandwidth network is defined as a network having sufficiently low latency and sufficiently high bandwidth so that participants can provide services (e.g., storage services) and satisfy data access service requirements (e.g., service level agreements (SLAs), quality of service (QoS) levels, or any other contracted or guaranteed performance) of an entity (e.g., a customer) to which the services are provided. This creates a substantially consistent storage system because redundancy established across the two participants creates highly available storage that can remain operational for data accesses through failure of one of the participants. The third participant (e.g., the secondary-tier node 102c) of the three-participant multi-DC quorum-based system 100 can be connected via a higher latency and lower bandwidth network. As used herein, a higher latency and lower bandwidth network is defined as a network that need not satisfy (although it may satisfy) data access service requirements for storage services. As described below, the third participant on the higher latency and lower bandwidth network is provided to establish a quorum when voting for a leader node of the cluster even if one of the first or second participants in the low-latency, high-bandwidth network becomes unavailable (e.g., fails).

In examples disclosed herein, a primary-tier participant or primary-tier node is a participant connected with low-latency, high-bandwidth networks. Also, in examples disclosed herein, a secondary-tier participant or secondary-tier node is a participant connected with higher-latency and/or lower-bandwidth networks.

As used herein, a primary-tier participant or node is a distinct node service that participates in leader election and can become the leader if it gets majority votes from other participants. As such, primary-tier participants may also be referred to as candidate voters, leader-eligible participants, or leader-eligible nodes. In example FIG. 1, the first primary-tier node 102a and the second primary-tier node 102b can become a leader. In addition, at any point in time, at least one of the first primary-tier node 102a or the second primary-tier node 102b is available to participate in leader election.

As used herein, a secondary-tier participant or node is a distinct node service that participates in voting for leader election, but is not an electable candidate to become a leader. As such, the secondary-tier node 102c may also be referred to as a non-candidate voter, a follower-only participant, or a leader-ineligible participant because it does not assume the role of an electable candidate in leader elections.

To provide connectivity to a low-latency, high-bandwidth network, the first primary-tier node 102a is hosted by an example first data center 104a and the second primary-tier node 102b is hosted by an example second data center 104b. The secondary-tier node 102c is hosted by an example cloud system 106, which could provide a higher latency and lower bandwidth network compared to the networks of the data centers 104a,b. In example FIG. 1, the cloud 106 may be a private cloud, a public cloud, or a heterogeneous cloud (e.g., a cloud including private cloud resources and public cloud resources). In other examples, the secondary-tier node 102c could instead be hosted on a third data center or in a separate availability zone or failure domain in one of the data centers 104a,b separate from the availability zones of the first primary-tier node 102a and the second primary-tier node 102b.

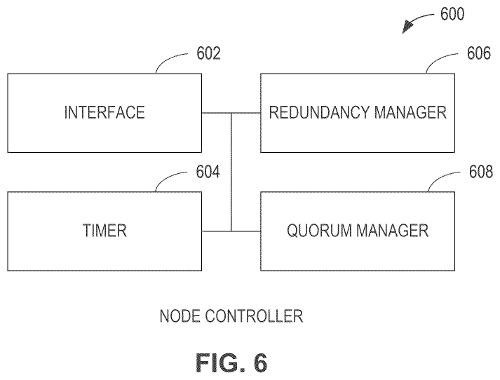

In example FIG. 1, each of the nodes 102a-c includes a corresponding example node controller 108a-c. The node controllers 108a-c control operations of the nodes 102a-c related to leadership voting and to managing, storing, and replicating data and/or metadata. An example implementation of the node controllers 108a-c is described below in connection with FIG. 6.

In some examples, the first primary-tier node 102a and the second primary-tier node 102b are instantiated on dedicated physical hardware (e.g., dedicated servers) in corresponding ones of the first data center 104a and the second data center 104b. In other examples, the first primary-tier node 102a and the second primary-tier node 102b are instantiated on virtual resources such as virtual machines or containers at their respective data centers 104a,b. In example FIG. 1, the secondary-tier node 102c is instantiated on cloud resources in the cloud system 106.

In example FIG. 1, the first data center 104a is a first availability zone, the second data center 104b is a second availability zone, and the cloud 106 is a third availability zone. As such, the first data center 104a implements a first failure domain, the second data center 104b implements a second failure domain, and the cloud 106 implements a third failure domain such that upon failure of any of the nodes 102a-c, the other, non-failed ones of the nodes 102a-c remain operational in their respective failure domains or availability zones.

The secondary-tier node 102c satisfies a quorum for the quorum-based system 100 even if the secondary-tier node 102c does not necessarily contribute to the high level of availability supported by the first primary-tier node 102a and the second primary-tier node 102b. During normal operation, the quorum-based system 100 can maintain a high level of performance based on the first primary-tier node 102a and the second primary-tier node 102b being connected via one or more low-latency, high-bandwidth networks across the data centers 104a,b. Concurrently, the quorum-based system 100 is able to satisfy quorum for voting events based on the additional secondary-tier node 102c connected via the higher latency, lower bandwidth network corresponding to the cloud 106.

In example FIG. 1, one or more example first application(s) 112a of one or more user application(s) is/are executed in the first data center 104a and one or more example second application(s) 112b of the one or more user application(s) is/are executed in the second data center 104b. Although each primary-tier node 102a,b may include multiple application(s) to access data in the corresponding data centers 104a,b, for purposes of simplicity in examples disclosed herein, a single first application 112a is referenced for the first primary-tier node 102a and a single second application 112b is referenced for the second primary-tier node 102b. The first and second applications 112a,b may be different applications or may be copies or replicas of one another. In any case, the first and second applications 112a,b communicate with the primary-tier nodes 102a,b to, for example, access data in the corresponding data centers 104a,b. The applications 112a,b may be multimedia applications, neural networks, artificial intelligence (AI) engines, or any other data processing applications. The applications 112a,b run in parallel to provide redundancy and failover operation to an end-user in the event of a failure or unavailability of either one of the applications 112a,b. In operation, the applications 112a,b send data access requests to whichever one of the primary-tier nodes 102a,b is the leader node. In example FIG. 1, the secondary-tier node 102c, which is outside of the data centers 104a,b, can only assume a follower role. As such, in example FIG. 1, the user applications 112a,b need not communicate with the secondary-tier node 102c.

In examples disclosed herein, the quorum-based system 100 stores metadata. In some examples, a distributed storage system implemented by the quorum-based system 100 stores both data and metadata. As used herein, metadata includes an object key namespace or a data-block map of an object key for a corresponding object in storage. As used herein, data is the actual data contents of the object. In example FIG. 1, the first data center 104a includes a first storage node 110a in communication with the first primary-tier node 102a, and the second data center 104a includes a second storage node 110b in communication with the second primary-tier node 102b. In some examples, the data may be stored in the storage nodes 110a,b in data blocks organized in block groups. In such examples, the first primary-tier node 102a stores metadata and the first storage node 110a stores data accessible by the first primary-tier node 102a based on requests from the user application 112a. The metadata is a copy or replication of redundant metadata stored at the second primary-tier node 102b and at the secondary-tier node 102c. The data is a copy or replication of redundant data stored at the second storage node 110b. However, the redundant data is not stored in the cloud system 106. That is, the secondary-tier node 102c in the cloud system 106 stores the metadata but the cloud system 106 does not store the data. In this manner, upon a failure or unavailability of a primary-tier node 102a,b, the available one of the primary-tier nodes 102a,b can update or synchronize its metadata based on the metadata of the secondary-tier node 102c.

In some examples, storage layouts corresponding to the first primary-tier node 102a and the second primary-tier node 102b can be split between their two availability zones (e.g., the data centers 104a,b). The storage layouts can be split using chained replication 4 (e.g., 2 replicas in each availability zone) or a Forward Error Correction modes model. For the metadata part of such a storage system, the metadata copies are stored on all participants. For example, as described above, the metadata is stored/replicated in all of the nodes 102a-c.

In examples disclosed herein, only the two primary-tier nodes 102a,b need to be in highly trusted and highly secure data centers. The secondary-tier node 102c can reside in a less trusted environment (e.g., a public cloud). The example consistent and heterogeneous quorum-based system 100 disclosed herein provides the same level of security and privacy as though all three nodes 102a-c were in a trusted and secure environment. For example, the two primary-tier nodes 102a,b are provided with encryption keys (also referred to as decryption keys) to encrypt and decrypt data, metadata, and command logs because their trusted environments are sufficiently secure to have that information in an unencrypted state for use by the two primary-tier nodes 102a,b. Since the secondary-tier node 102c does not use the metadata or the command log, the metadata and the command log may remain in an encrypted state in the secondary-tier node 102c. As such, encryption keys are not provided to the secondary-tier node 102c. In this manner, the secondary-tier node 102c does not decrypt the metadata and the command log, thereby, substantially decreasing the likelihood that a malicious process or malicious actor can access the decrypted metadata or command log from the secondary-tier node 102c.

Since one replica of the metadata is saved outside of the data centers 104a,b, examples disclosed herein provide a strong data encryption method for the secondary-tier node 102c. In such examples, the secondary-tier node 102c is mainly used for two purposes in the cluster. The first purpose is to participate in leader election. The second purpose is to provide one backup copy of metadata, which is used by the leader node in the event that both of the primary-tier nodes 102a,b are failed or unavailable and one of the primary-tier nodes 102a,b becomes available again for leader election. In such an event, the metadata in the secondary-tier 102c can be used by a primary-tier node 102a,b to reconstruct corresponding data. As such, in the event that one node fails, a quorum system implemented with three or more nodes in accordance with teachings of this disclosure can continue to operate and provide high availability of stored data based on the non-failed nodes. For example, examples disclosed herein are able to tolerate the complete and total failure of any one of the three nodes 102a-c of FIG. 1 while still providing availability of stored data in corresponding storage node(s) (e.g., the storage nodes 110a,b) of the non-failed one(s) of the primary-tier node(s) 102a,b.

In some examples, the quorum-based system 100 runs a consensus ring protocol across the three nodes 102a-c. Example consensus ring protocols that may be used include the RAFT consensus ring protocol and the Paxos consensus ring protocol. An example of the RAFT consensus ring protocol is Apache Ratis provided by The Apache Software Foundation. However, examples disclosed herein may be implemented with any other consensus ring protocol. In a consensus ring protocol, multiple nodes (e.g., the nodes 102a-c) in a cluster consensus ring work together to store the same agreed upon data in corresponding storage nodes (e.g., the storage nodes 110a,b). Since the same data or values are replicated by multiple nodes of the consensus ring, the consensus ring can continue operating to provide access to those values even if one of the nodes in the cluster consensus ring fails. When a user application (e.g., the user applications 112a,b) accesses the data in the quorum-based system 100, the user application believes it is interacting with a single node. In this manner, even if one of the primary-tier nodes 102a,b fails, the quorum-based system 100 still appears as a single node to the user application.

Examples disclosed herein may be implemented with N×2+1 voting nodes so that quorum-based voting for leadership election can be conducted. For example, if N=3 nodes, two can be in a low-latency, high-bandwidth network (e.g., the data centers 104a,b), and one can operate in a higher latency, lower bandwidth network (e.g., the cloud system 106). Alternatively, if N=5 nodes, three can be in a low-latency, high-bandwidth network (e.g., the data centers 104a,b), and two can operate in a higher latency, lower bandwidth network (e.g., the cloud system 106).

In operation, the nodes 102a-c perform a voting procedure in accordance with the consensus ring protocol to elect a leader node at different points in time. For example, each node 102a-c is provided a countdown timer (e.g., the timer 604 of FIG. 6) which, upon expiration, causes the respective node 102a-c to initiate a leadership voting process. For example, when the countdown timer of the first primary-tier node 102a expires, the first primary-tier node 102a transmits (e.g., broadcasts) a leader candidate advertisement to the second primary-tier node 102b and the secondary-tier node 102c. Upon receipt of the leader candidate advertisement, the second primary-tier node 102b and the secondary-tier node 102c respond by sending their votes to elect the first primary-tier node 102a as the leader. In addition, the first primary-tier node 102a self-votes to choose itself as the leader. In this manner, the first primary-tier node 102a is elected by quorum as the leader node. After all of the nodes 102a-c agree on a leader node, the ones of the nodes 102a-c not elected as leader take on roles of follower nodes. In addition, all of the nodes 102a-c reset their countdown timers.

In examples disclosed herein, each of the nodes 102a-c stores a command log (e.g., a raft log) that stores transaction commands. Transaction commands can be executed by the primary-tier nodes 102a,b to apply changes to data in the storage nodes 110a,b. The transaction commands are written to the corresponding command log of the nodes 102a-c. To apply transaction commands, the primary-tier nodes 102a,b execute the transaction commands from their command logs until the commands have been drained (e.g., no commands remain) from their corresponding command logs. In this manner, each of the primary-tier nodes 102a,b processes the same series of commands, thereby committing the same changes to its corresponding data so that data is replicated identically by both of the primary-tier nodes 102a,b in their corresponding storage nodes 110a,b.

After a leadership voting procedure in which the first primary-tier node 102a is elected as the leader, the first primary-tier node 102a in the leader role handles client requests received from the first user application 112a. In addition, the first primary-tier node 102a in the leader role transmits commands during an apply transaction phase to the follower nodes 102b,c. The transaction commands may include metadata by itself, data by itself, or both metadata and data.

The executions of the transaction commands are performed atomically cluster-wide across primary-tier nodes (e.g., the primary-tier nodes 102a,b) so that data updates are performed through completion by all of the primary-tier nodes or are not committed at all. In this manner, data updates are not inadvertently applied partially which could compromise the accuracy of the stored data. In addition, in the event of a failed commit of a data update, a transaction command replay is idempotent so that retrying the data update across the primary-tier nodes 102a,b does not result in compounding multiple ones of the same changes but instead results in updating the data as if the transaction command were applied only once.

Although only the primary-tier nodes 102a,b execute the transaction commands to update corresponding data, the status of the command logs is synchronized across the primary-tier nodes 102a,b and the secondary-tier node 102c so that the secondary-tier node 102c can maintain an up-to-date copy of the command log in the event of failure or unavailability of one or both of the primary-tier nodes 102a,b. Upon such a failure or unavailability, the available one of the primary-tier nodes 102a,b can update or synchronize its command log based on the command log of the secondary-tier node 102c.

In the three-node quorum-based system 100 of FIG. 1, the higher latency and lower throughput of the secondary-tier node 102c creates a challenge in keeping the quorum-based system 100 efficient when the secondary-tier node 102c is a lagging, non-candidate voter node. It also creates a second challenge in that the secondary-tier node 102c can attempt to become a leader in consensus ring protocols (e.g., in RAFT-like algorithms). This could be unacceptable to some user applications running in the quorum-based system 100 if the secondary-tier node 102c is hosted in a higher latency and less secure environment (e.g., a public cloud). However, in examples disclosed herein, the primary-tier nodes 102a,b are configured to advertise their leadership candidacy and the secondary-tier node 102c is configured to not advertise leadership candidacy. As such, the secondary-tier node 102c participates in a follower-only role. This follower-only role of the secondary-tier node 102c allows the secondary-tier node 102c to be involved in voting for the other nodes (e.g., the primary-tier nodes 102a,b) in the consensus ring protocol. However, the secondary-tier node 102c in such follower-only role does not become an electable candidate for leader election.

In examples disclosed herein, the leader role is assumed by either of the primary-tier nodes 102a,b in, for example, the data centers 104a,b. The user applications 112a,b communicate with the primary-tier nodes 102a,b because those nodes can become leaders. The user applications 112a,b communicate with the elected leader node for any metadata update operations.

When the secondary-tier node 102c fails, the quorum-based system 100 continues to operate with a leader elected based on majority voting among the two primary-tier nodes 102a,b. Since the secondary-tier node 102c does not become the leader, it operates as a backup copy of the replica metadata. The secondary-tier node 102c stores a command log (e.g., a RAFT log) of transaction commands and an active image of the metadata state from the leader node. As such, at any point in time, the local command log (e.g., RAFT log) and the base metadata image stored at the secondary-tier node 102c provides a complete metadata state for use by a leader node to reconstruct any lost data. In some examples, the metadata as well as any command log (e.g., RAFT log) transferred to the secondary-tier node 102c is encrypted. Such encryption may be implemented as a selectable option for users to choose depending on their security and privacy requirements. Since the secondary-tier node 102c does not use the metadata or the command log, the metadata and the command log may remain in an encrypted state in the secondary-tier node 102c. In examples in which the secondary-tier node 102c is provisioned in a less secure environment (e.g., a public network, a less trusted network than a data center, etc.) than the environments of the primary-tier nodes 102a,b, decryption keys are not provided to the secondary-tier node 102c. In this manner, decrypted states of the metadata and the command log cannot be accessed at the secondary-tier node 102c by a malicious process or malicious actor.

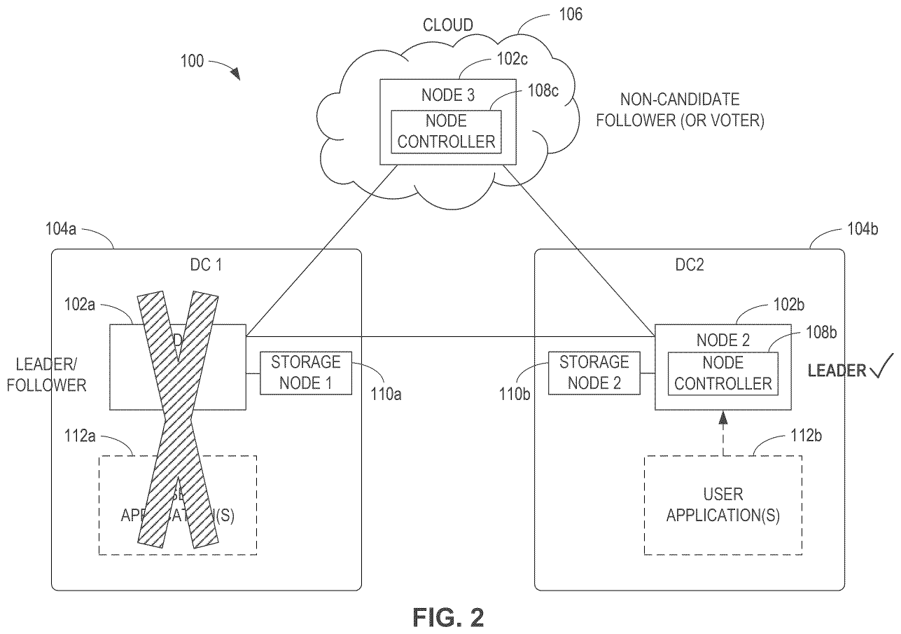

FIG. 2 shows a scenario of the quorum-based system 100 of FIG. 1 in which the primary-tier node 102a in the first data center 104a becomes unavailable. When the first primary-tier node 102a in the first data center 104a becomes unavailable (e.g., goes down or fails), the second primary-tier node 102b in the second data center 104b forms a quorum with the secondary-tier node 102c in the cloud 106. As part of quorum building, both the second primary-tier node 102b at the second data center 104b and the secondary-tier node 102c in the cloud 106 reconcile their command logs, synchronize their transaction command execution status, and continue from the latest transaction present in their command logs. At this point, the quorum-based system 100 can continue to accept new transaction commands from the second user application 112b.

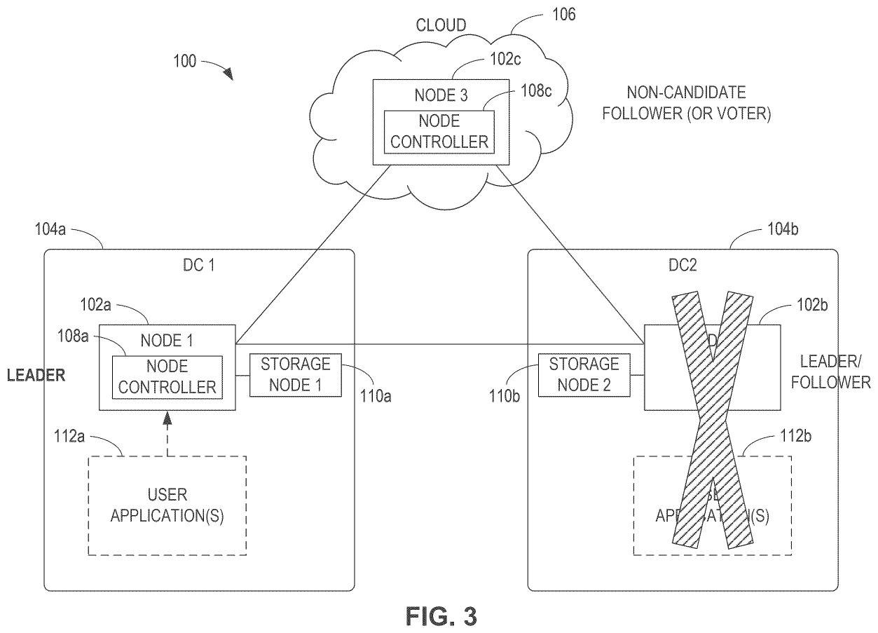

FIG. 3 shows another scenario of the quorum-based system 100 of FIG. 1 in which the second primary-tier node 102b in the second data center 104b becomes unavailable. When the second primary-tier node 102b in the second data center 104b becomes unavailable (e.g., goes down or fails), the first primary-tier node 102a in the first data center 104a forms a quorum with the secondary-tier node 102c in the cloud 106. As part of quorum building, both the first primary-tier node 102a at the first data center 104a and the secondary-tier node 102c in the cloud 106 reconcile their command logs, synchronize their transaction command execution status, and continue from the latest transaction present in their command logs. At this point, the quorum-based system 100 can continue to accept new transaction commands from the first user application 112a.

If there is a ping-pong failure in which the first primary-tier node 102a in the first data center 104a goes down, fails, or otherwise becomes unavailable when the second primary-tier node 102b in the second data center 104b is unavailable, and the second primary-tier node 102b comes back online, two active participants are available to form a new quorum (e.g., the second primary-tier node 102b in the second data center 104b and the secondary-tier node 102c in the cloud 106). It is only the secondary-tier node 102c in the cloud 106 that has newer transaction commands in its command log. These two active participants can again synchronize their command logs so that the second primary-tier node 102b in the second data center 104b catches up by applying transaction commands obtained from the up-to-date command log in the secondary-tier node 102c. At that point, the second primary-tier node 102b in the second data center 104b is ready to become the leader node in the quorum again. Also at that point, the quorum-based system 100 can start serving reads/writes and continue to operate normally.

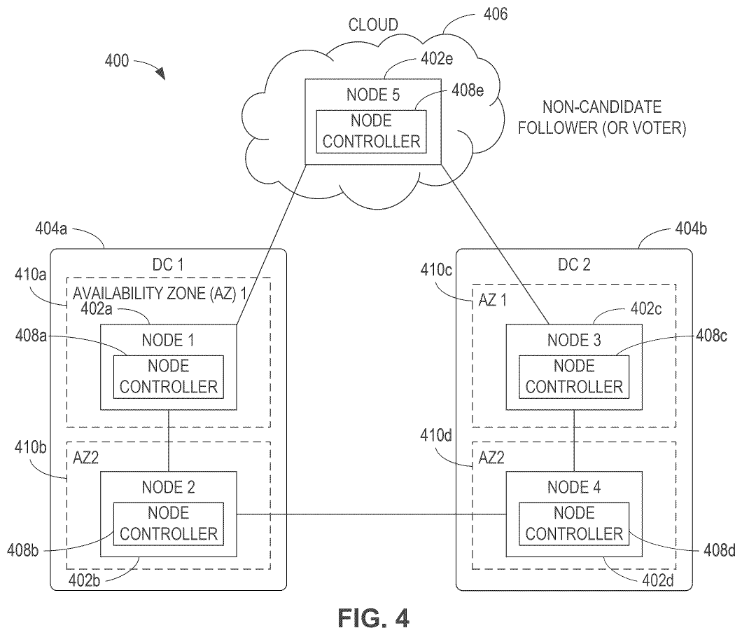

Referring to FIG. 4, example first and second primary-tier nodes 402a,b are in an example first data center 404a, example third and fourth primary-tier nodes 402c,d are in an example second data center 404b, and an example secondary-tier node 402e is in an example cloud system 406. To provide failure-isolation between the first and second primary-tier nodes 402a,b, the first data center 404a includes an example first availability zone (AZ) 410a and an example second availability zone 410b. The first primary-tier node 402a is in the first availability zone 410a so that it is failure-isolated from the second primary-tier node 402b located in the second availability zone 410b. Also, to provide failure-isolation between the third and fourth primary-tier nodes 402c,d, the second data center 404b includes an example third availability zone 410c and an example fourth availability zone 410d. The third primary-tier node 402c is in the third availability zone 410c so that it is failure-isolated from the fourth primary-tier node 402d located in the fourth availability zone 410d. The cloud system 406 is its own availability zone separate from the availability zones 410a-d of the data centers 404a,b.

In addition, the nodes 402a-e include corresponding example node controllers 408a-e which are substantially similar or identical to the node controllers 108a-c of FIGS. 1-3. Although not shown, each of the availability zones 410a-d includes a storage node and a user application that accesses data in each of the storage nodes. The storage nodes can be substantially similar or identical to the storage nodes 110a,b of FIGS. 1-3. The user applications can be substantially similar or identical to the user applications 112a,b of FIGS. 1-3.

By having the two availability zones 410a,b in the first data center 404a and two availability zones 410c,d in the second data center 404b, when one node fails in either data center 404a,b, the remaining three active nodes in the data centers 404a,b can still achieve quorum, which requires at least three nodes. As such, the quorum-based system configuration of FIG. 4 does not need to rely on the secondary-tier node 402e in the cloud system 406 for quorum in the event of a single-node failure in one of the data centers 404a,b.

Quorum-based systems in accordance with examples disclosed herein can be built using any suitable consensus ring protocol (e.g., RAFT-like algorithms). For example, such consensus ring protocols support a feature called “reads from followers or stale node reads.” In some examples, client reads from the secondary-tier node 402e in the cloud 406 are restricted. This restriction applies only to this specially designated secondary-tier node 402e that operates as a follower-only node. Primary-tier participants (e.g., the primary tier nodes 402a-d), which can at times operate as follower nodes, can still serve the “reads from follower” requests. In the five-participant quorum-based system 400, built in accordance with examples disclosed herein (e.g., the two primary-tier nodes 402a,b in the first data center 404a, the two primary-tier nodes 402c,d in the second data center 404b, and the one secondary-tier node 402e in the cloud 406), four primary-tier nodes are available to serve reads. In this manner, read input/output operations per second (IOPS) of the quorum-based system 400 can be scaled using this “reads from followers” feature of consensus ring protocols such as RAFT.

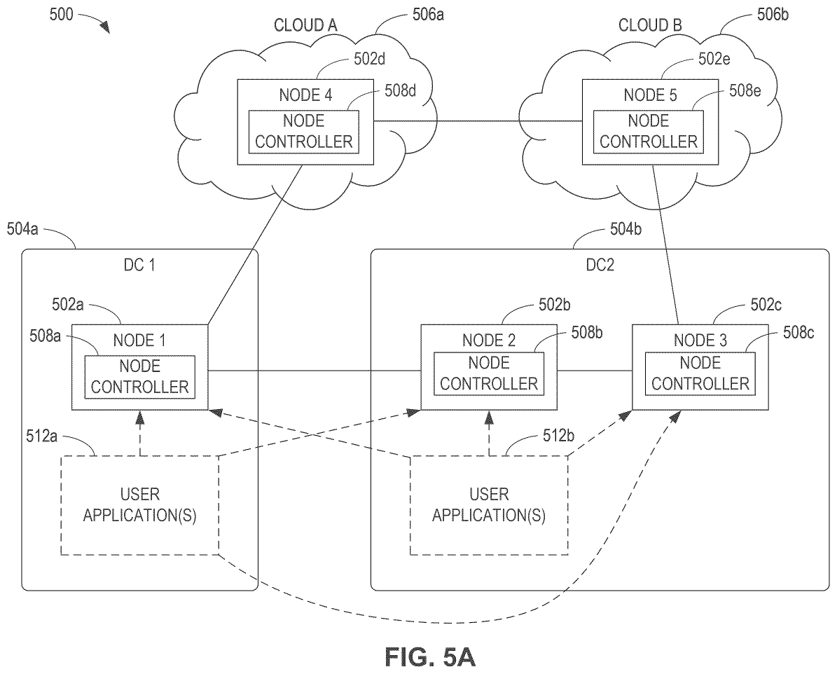

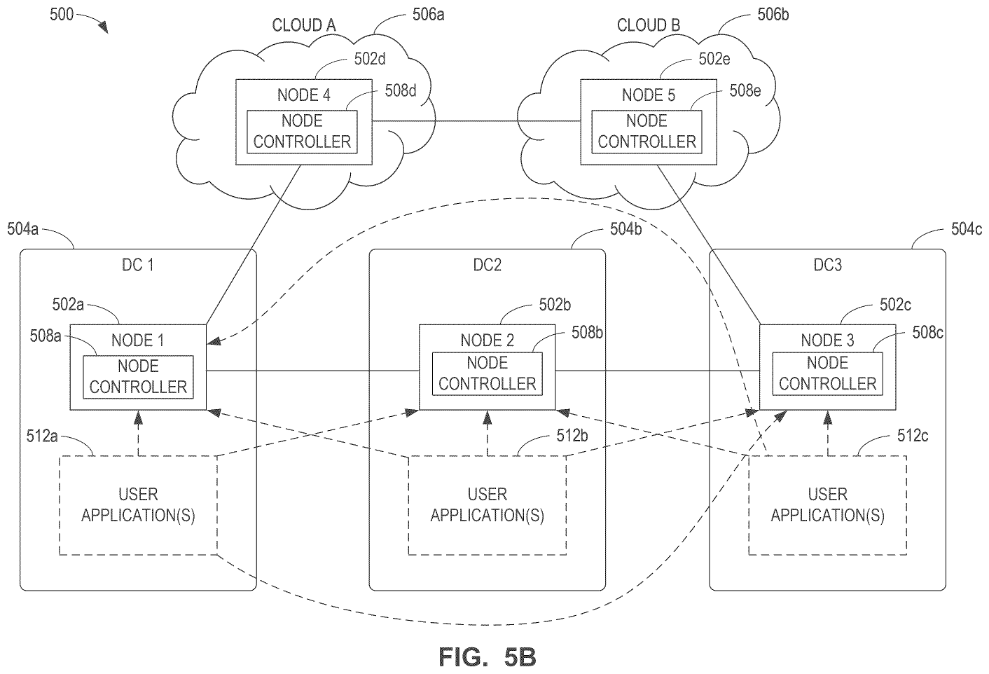

FIG. 5A is a block diagram of an example five-participant quorum-based system 500 that includes an example first primary-tier node 502a in an example first data center 504a and that includes an example second primary-tier node 502b and an example third primary-tier node 502c in a second data center 504b. The five-participant quorum-based system 500 also includes example first and second secondary-tier nodes 502d,e in corresponding cloud systems 506a,b. In example FIG. 5A, first and second user applications 512a,b operate in corresponding ones of the data centers 504a,b to access data in storage nodes at the data centers 504a,b. Although each data center 504a,b may include multiple application(s) to access data, for purposes of simplicity in examples disclosed herein, a single first application 512a is referenced in the first data center 504a and a single second application 512b is referenced in the second data center 504b. In this manner, each of the user applications 512a,b can operate in place of any failed one of the user applications 512a,b. In addition, each of the nodes 502a-e includes a corresponding example node controller 508a-e. The node controllers 508a-e are substantially similar or identical to the node controllers 108a-c of FIGS. 1-3 and the node controllers 408a-e of FIG. 4.

When two data centers are provided, as in example FIG. 5A, the five-participant quorum-based system 500 can continue operating even after a failure of one data center. That is, even when one of the data centers 504a,b fails, a quorum of three nodes can still be achieved based on the remaining one of the data centers 504a,b and one or both of the cloud systems 506a,b. For example, if the second data center 504b fails, both of the second primary-tier node 502b and the third primary-tier node 502c become unavailable. However, a quorum of three is still satisfied by the first primary-tier node 502a of the first data center 504a and the two secondary-tier nodes 502d,e in the corresponding cloud systems 506a,b. In such an example, a vote by the first primary-tier node 502a and the secondary-tier nodes 502d,e results in the first primary-tier node 502a being elected as the leader node. Alternatively, if the first data center 504a fails, the first primary-tier node 502a becomes unavailable. However, a quorum of three is still satisfied by the first and second primary-tier nodes 502b,c in the second data center 504b and at least one of the first and second secondary-tier nodes 502d,e in the corresponding cloud systems 506a,b. In such an example, a vote by the second and third primary-tier nodes 502b,c and the at least one of the secondary-tier nodes 502d,e results in one of the second or third primary-tier nodes 502b,c being elected as the leader node.

Turning to FIG. 5B, another example five-participant quorum-based system 550 includes the first, second, and third primary-tier participant nodes 502a-c in corresponding ones of three data centers 504a-c and the first and second secondary-tier nodes 502d,e in the corresponding clouds 506a,b. Thus, unlike the five-participant quorum-based system 500 of FIG. 5A, the five-participant quorum-based system 550 of FIG. 5B includes a third data center 504c that hosts the third primary-tier participant node 502c. In example FIG. 5B, the first and second user applications 512a,b operate in corresponding ones of the first and second data centers 504a,b to access data in storage nodes at those data centers 504a,b. In addition, a third user application 512c operates in the third data center 504c.

When availability zones are expanded to three or a greater odd number, secondary-tier nodes can be proportionately increased outside of data center-based availability zones to improve node-failure tolerance. For example, because the quorum-based system 550 of FIG. 5B has three primary-tier nodes 502a-c in three availability zones implemented by corresponding ones of the three data centers 504a-c, the two secondary-tier nodes 502d,e in the clouds 506a,b are added to create a five-node cluster. In this case, the quorum-based system 550 can tolerate a failure or unavailability of up to two of the data centers 504a-c because the remaining one of the primary-tier nodes 502a-c becomes a leader node with the two secondary-tier nodes 502d,e being follower nodes in the cluster.

FIG. 6 is a block diagram of an example implementation of an example node controller 600 that may be used to implement the node controllers 108a-c of FIGS. 1-3, the node controllers 408a-e of FIG. 4, and the node controllers 508a-e of FIGS. 5A and 5B. The node controller 600 is to control operations of nodes (e.g., the 102a-c of FIGS. 1-3, the nodes 402a-e of FIG. 4, and the nodes 502a-e of FIGS. 5A and 5B) related to leadership voting and to managing, storing, and replicating metadata. The node controller 600 includes an example interface 602, an example timer 604, an example redundancy manager 606, and an example quorum manager 608.

The node controller 600 of FIG. 6 may be instantiated (e.g., creating an instance of, bring into being, materialize, implement, etc.) by programmable circuitry such as a Central Processor Unit (CPU) executing instructions. Additionally or alternatively, the node controller 600 of FIG. 6 may be instantiated (e.g., creating an instance of, bring into being, materialize, implement, etc.) by (i) an Application Specific Integrated Circuit (ASIC) and/or (ii) a Field Programmable Gate Array (FPGA) structured and/or configured to perform operations of the node controller 600. It should be understood that some or all of the circuitry of FIG. 6 may be instantiated at the same or different times. Moreover, in some examples, some or all of the circuitry of FIG. 6 may be implemented by microprocessor circuitry executing instructions and/or FPGA circuitry performing operations to implement one or more virtual machines and/or containers.

The interface 602 is provided to communicate with other nodes (e.g., the nodes 102a-c of FIGS. 1-3, the nodes 402a-e of FIG. 4, or the nodes 502a-e of FIGS. 5A and 5B) and with applications (e.g., the user applications 112a,b of FIGS. 1-3, the user applications 512a-c of FIGS. 5A and/or 5B). For example, the interface 602 may transmit (e.g., broadcast) leader candidate advertisements to other nodes to inform such other nodes that the transmitting node is soliciting votes to be elected as a leader node. The interface 602 may also transmit and receive transaction commands to synchronize command logs across nodes. The interface 602 may also transmit and receive metadata to synchronize metadata across nodes. In addition, the interface 602 receives requests from applications such as the user applications 112a,b and 512a-c and transmits results to the applications.

The timer 604 is provided to implement a countdown timer that tracks when a corresponding node is to broadcast a leader candidate advertisement to other nodes. The timer 604 may be set to any time established for or agreed upon by the nodes. Upon expiration of the configured time, the timer 604 may generate an interrupt indicative of expiration. Alternatively, the timer 604 may be poled by a process to determine when the timer 604 expires.

The redundancy manager 606 is provided to synchronize command logs and/or metadata across nodes (e.g., the nodes 102a-c of FIGS. 1-3, the nodes 402a-e of FIG. 4, or the nodes 502a-e of FIGS. 5A and 5B). For example, the redundancy manager 606 may coordinate replications of command logs and/or metadata across the nodes to confirm that such information at a local node matches replications at other nodes in the same cluster. The redundancy manager 606 may also be used to confirm that the same transaction commands are committed by all the available or operating primary-tier nodes of the cluster. By committing the same changes to data by a local primary-tier node and other primary-tier nodes of the cluster, the redundancy manager 606 confirms that data is replicated identically by all the available primary-tier nodes.

The quorum manager 608 is provided to handle leader voting processes. For example, the quorum manager 608 casts votes for a leader node, receives votes from other nodes, and tallies votes to confirm the votes satisfy a quorum to designate a leader node. For example, in response to expiration of the timer 604 at a node of the node controller 600, the quorum manager 608 causes the interface 602 to broadcast a leader candidate advertisement. Also in response to the expiration of the timer 604, the quorum manager 608 self-votes for its node to be elected as the leader node. The quorum manager 608 waits for votes received by the interface 602 from other nodes. Each vote received by the interface 602 from another node of the same cluster is a vote for the node of the node controller 600. The quorum manager 608 tallies the received vote(s) and the self-vote to determine whether the vote tally satisfies a quorum to designate the node of the node controller 600 as the leader node. If so, the node of the node controller 600 assumes the leader role and the other nodes of the same cluster assume follower roles.

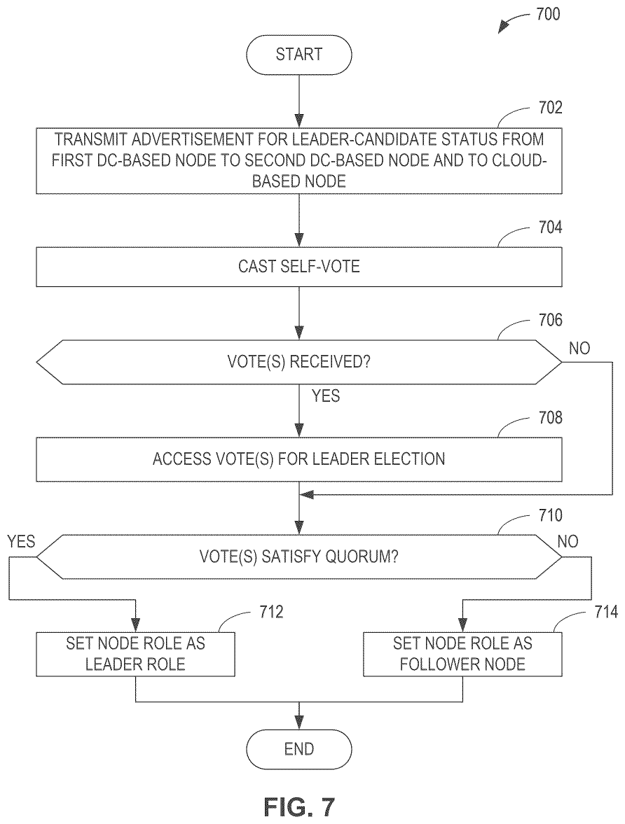

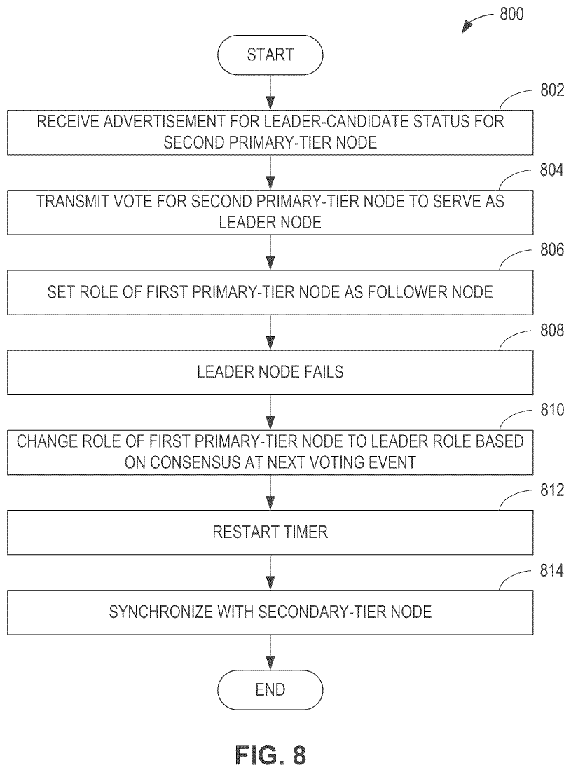

In some examples, the interface 602, the timer 604, the redundancy manager 606, and the quorum manager 608 are circuitry (e.g., interface circuitry, timer circuitry, redundancy manager circuitry, and quorum manager circuitry) instantiated by programmable circuitry executing instructions and/or configured to perform operations such as those represented by the flowcharts of FIGS. 7 and 8.

As described above, the interface 602, the timer 604, the redundancy manager 606, and the quorum manager 608 of FIG. 6 are structures. Such structures may implement means for performing corresponding disclosed functions. Examples of such functions are described above in connection with corresponding ones of the interface 602, the timer 604, the redundancy manager 606, and the quorum manager 608 and are described below in connection with the flowcharts of FIGS. 7 and 8.

While an example manner of implementing the node controller 600 of FIG. 1 is illustrated in FIG. 6, one or more of the elements, processes, and/or devices illustrated in FIG. 6 may be combined, divided, re-arranged, omitted, eliminated, and/or implemented in any other way. Further, the interface 602, the timer 604, the redundancy manager 606, the quorum manager 608, and/or, more generally, the example node controller 600 of FIG. 6, may be implemented by hardware alone or by hardware in combination with software and/or firmware. Thus, for example, any of the interface 602, the timer 604, the redundancy manager 606, the quorum manager 608, and/or, more generally, the example node controller 600, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example node controller 600 of FIG. 6 may include one or more elements, processes, and/or devices in addition to, or instead of, those illustrated in FIG. 6, and/or may include more than one of any or all of the illustrated elements, processes and devices.

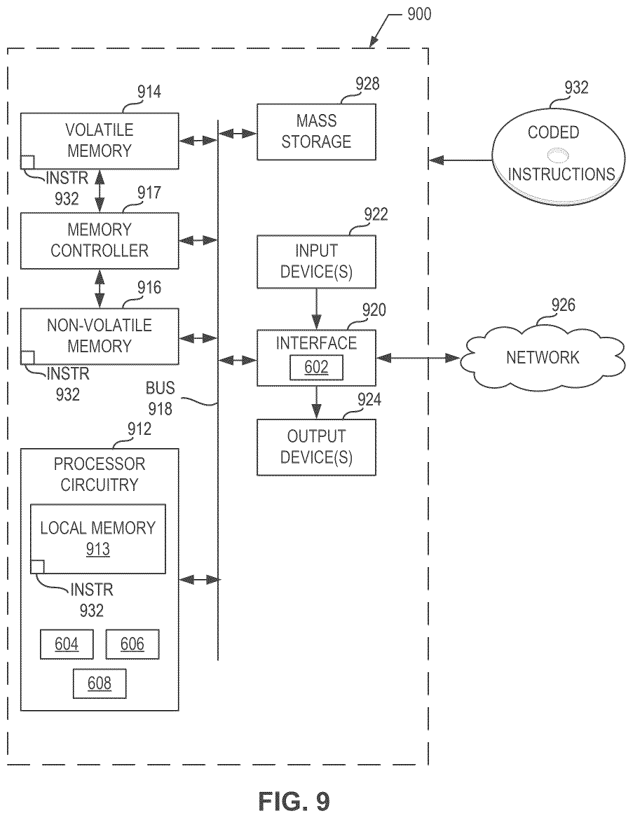

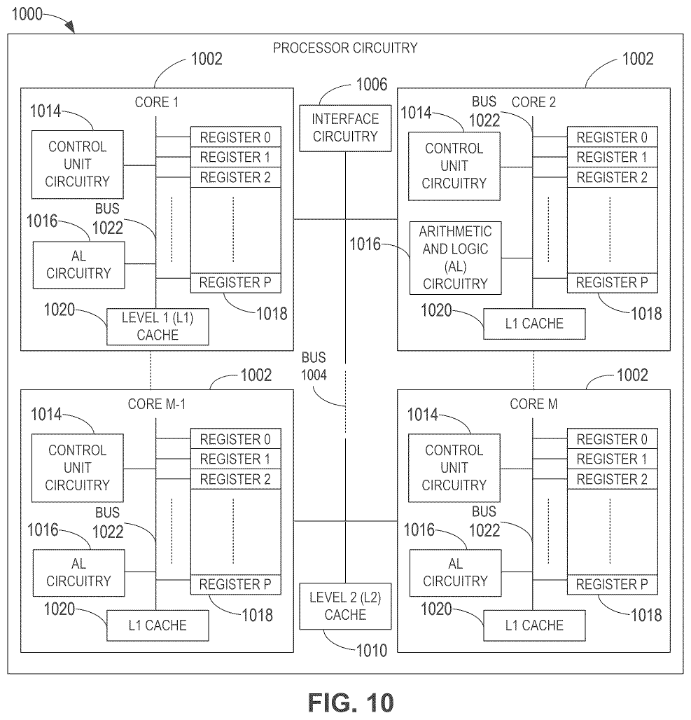

Flowcharts representative of example machine-readable instructions, which may be executed by programmable circuitry to implement and/or instantiate the node controller 600 of FIG. 6 and/or representative of example operations which may be performed by programmable circuitry to implement and/or instantiate the node controller 600 of FIG. 6, are shown in FIGS. 7 and 8. The machine-readable instructions may be one or more executable program(s) or portion(s) of one or more executable program(s) for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine-readable storage media such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, read-only memory (ROM), a solid-state drive (SSD), non-volatile memory (e.g., electrically erasable programmable ROM (EEPROM), flash memory, etc.), volatile memory (e.g., Random Access Memory (RAM) of any type, etc.), and/or any other storage device or storage disk. The non-transitory computer readable storage medium may include one or more mediums and/or types of mediums. The instructions of the non-transitory computer readable and/or machine-readable medium may be executed and/or instantiated by one or more hardware devices other than the programmable circuitry and/or may be embodied in dedicated hardware. For example, any or all of the blocks of the flowcharts may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform corresponding operations without executing software or firmware.

Although the example program(s) is/are described with reference to the flowcharts illustrated in FIGS. 7 and 8, many other methods of implementing the example node controller 600 may alternatively be used. For example, the order of execution of the blocks of the flowcharts may be changed, and/or some of the blocks described may be changed, eliminated, or combined.

The machine-readable instructions may be distributed across multiple hardware devices and/or executed by two or more hardware devices (e.g., a server and a client hardware device). The programmable circuitry may be distributed in different network locations and/or may be local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

Machine-readable instructions as described herein may be stored as data and/or in a data structure (e.g., as portion(s) of instructions, code, representations of code, etc.) on one or more storage devices, disks and/or computing devices (e.g., servers) located at the same or different locations of a network or collection of networks (e.g., in the cloud, in edge devices, etc.).

The machine-readable instructions described herein can be written or represented using any suitable previously developed or future-developed instruction language, scripting language, programming language, etc. including, for example, C, C++, Java, C#, Perl, Python, JavaScript, HyperText Markup Language (HTML), Structured Query Language (SQL), Swift, etc.

As mentioned above, the example operations of FIGS. 7 and 8 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. As used herein, the terms “non-transitory computer-readable storage device” and “non-transitory machine readable storage device” are defined to include any physical (mechanical, magnetic and/or electrical) hardware to retain information for a time period, but to exclude propagating signals and to exclude transmission media. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc. As used herein, the term “storage disk” refers to a physical structure containing information storage elements to which information can be written and persisted for subsequent retrieval by a computer or other hardware platform. Examples of non-transitory computer-readable medium, non-transitory computer-readable storage medium, non-transitory machine-readable medium, non-transitory machine-readable storage medium, non-transitory computer-readable storage devices, non-transitory machine-readable storage devices, non-transitory computer-readable storage disk, and/or non-transitory machine-readable storage disk include any one of or combination of random access memory (RAM) of any type, read only memory (ROM) of any type, solid state memory, flash memory, optical discs (e.g., a CD, a DVD, etc.), magnetic disks (e.g., magnetic HDDs), disk drives, cache, registers, redundant array of independent disks (RAID) systems, and/or any other non-transitory computer-readable and/or machine-readable media in which information is stored for any duration (e.g., for extended time periods, permanently, for brief instances, for temporarily buffering, and/or for caching of the information).

FIG. 7 is a flowchart representative of example machine-readable instructions and/or example operations 700 that may be executed, instantiated, and/or performed by example programmable circuitry to implement the node controller 600 of FIG. 6 to set a leader role for a corresponding node in a quorum-based system (e.g., the quorum-based system 100 of FIGS. 1-3, the quorum-based system 400 of FIG. 4, the quorum-based system 500 of FIG. 5A, or the quorum-based system 550 of FIG. 5B). The instructions and/or operations 700 are described in connection with a three-node quorum-based system such as the quorum-based system 100 of FIGS. 1-3. However, the instructions and/or operations 700 may be similarly used with any other number of nodes. In addition, the instructions and/or operations 700 are described with respect to the node controller 600 (FIG. 6) being implemented in the first primary-tier node 102a (FIGS. 1-3). However, the instructions and/or operations 700 may be similarly used in any other primary-tier node.

The example machine-readable instructions and/or the example operations 700 of FIG. 7 begin at block 702, at which the interface 602 (FIG. 6) transmits (e.g., broadcasts) a leader candidate advertisement from the first primary-tier node 102a of the first data center 104a (e.g., a first availability zone) to the second primary-tier node 102b in the second data center 104b (e.g., a second availability zone) and the secondary-tier node 102c in the cloud system 106 (e.g., a third availability zone). For example, the interface 602 may transmit the leader candidate advertisement in response to expiration of the timer 604. The leader candidate advertisement specifies a leader-candidate status for the first primary-tier node 102a. The first primary-tier node 102a and the second primary-tier node 102b are eligible to vote for a leader and eligible to serve in a leader role. The secondary-tier node 102c is also eligible to vote for the leader. However, the secondary-tier node 102c is ineligible to serve in the leader role.

The quorum manager 608 (FIG. 6) casts a self-vote (block 704). For example, the quorum manager 608 casts a self-vote for its first primary-tier node 102a to serve in the leader role. The quorum manager 608 may store the self-vote in a buffer or other reserved memory space or register space. The quorum manager 608 determines whether any votes were received from other nodes (block 706). For example, the interface 602 may receive votes from one or more other nodes in the same cluster as the first primary-tier node 102e such as the second primary-tier node 102b in the second data center 104b and secondary-tier node 102c in the cloud system 106. To determine whether any such vote was received by the interface 602, the quorum manager 608 may check a vote buffer or other reserved memory space or register space that stores the incoming votes. If the quorum manager 608 determines that one or more votes were received (block 706: YES), control proceeds to block 708. Otherwise, if no votes were received (block 706: NO), control advances to block 710.

At block 708, the quorum manager 608 accesses the votes for leader election. In such example, the quorum manager 608 accesses the self-vote and one or more votes from the second primary-tier node 102b and/or the secondary-tier node 102c.

The quorum manager 608 determines whether the one or more vote(s) satisfy a quorum (block 710). For example, if the only vote was the self-vote, the quorum manager 608 determines that the self-vote does not satisfy the quorum. However, if the votes include the self-vote and at least one other vote from the second primary-tier node 102b or the secondary-tier node 102c, the quorum manager 608 determines that the votes do satisfy the quorum.

If the votes do satisfy the quorum to elect the first primary-tier node 102a as the leader node (block 710: YES), the quorum manager 608 sets the node role of the first primary-tier node 102a as the leader role (block 712). For example, the quorum manager 608 may configure a bit value or bit field of a register of the primary-tier node 102a to configure the primary-tier node 102a as the leader. In addition, the quorum manager 608 resets the timer 604. Otherwise, if the votes do not satisfy the quorum to elect the first primary-tier node 102a as the leader node (block 710: NO), the quorum manager 608 sets the node role of the first primary-tier node 102a as a follower node (block 714). For example, the quorum manager 608 may configure a bit value or bit field of a register of the primary-tier node 102a to configure the primary-tier node 102a as a follower. In addition, the quorum manager 608 resets the timer 604. The instructions and/or operations 700 of FIG. 7 end.

FIG. 8 is a flowchart representative of example machine-readable instructions and/or example operations 800 that may be executed, instantiated, and/or performed by example programmable circuitry to implement the node controller 600 of FIG. 6 to set a follower role for a corresponding node and change it to a leader role upon failure of a leader node. The instructions and/or operations 800 are described in connection with a three-node quorum-based system such as the quorum-based system 100 of FIGS. 1-3. However, the instructions and/or operations 800 may be similarly used with any other number of nodes. In addition, the instructions and/or operations 800 are described with respect to the node controller 600 (FIG. 6) being implemented in the first primary-tier node 102a (FIGS. 1-3). However, the instructions and/or operations 800 may be similarly used in any other primary-tier node.

The example machine-readable instructions and/or the example operations 800 of FIG. 8 begin at block 802, at which the interface 602 (FIG. 6) receives a leader candidate advertisement at the first primary-tier node 102a of the first data center 104a (e.g., a first availability zone) from the second primary-tier node 102b in the second data center 104b (e.g., a second availability zone). The leader candidate advertisement identifies a leader-candidate status for the second primary-tier node 102b.

The interface 602 transmits a vote for the second primary-tier node 102b to serve as a leader node (block 804). For example, the quorum manager 608 (FIG. 6) may process the leader candidate advertisement received at block 802 from the second primary-tier node 102b and cause the interface 602 to transmit the vote at block 804. The quorum manager 608 sets a role of the first primary-tier node 102a as follower node (block 806). For example, the quorum manager 608 may configure a bit value or bit field of a register of the primary-tier node 102a to configure the primary-tier node 102a as a follower. In addition, the quorum manager 608 resets the timer 604.

The leader node fails (block 808). When the leader node fails, the leader node does not renew its candidacy at a next voting event to serve as leader. At the next voting event, the quorum manager 608 changes the role of the first primary-tier node 102a from the follower role to the leader role based on a consensus (block 810). For example, a leader election can be conducted as described above in connection with the instructions and/or operations 700 of FIG. 7 to elect the first primary-tier node 102a to the leader role. After the quorum manager 608 changes the role of the first primary-tier node 102a to the leader role, the quorum manager 608 resets the timer 604 (block 812).

The redundancy manager 606 synchronizes the first primary-tier node 102a with the secondary-tier node 102c (block 814). For example, the redundancy manager 606 can update or synchronize the metadata and command log of the first primary-tier node 102a based on the metadata and command log of the secondary-tier node 102c to confirm that the metadata and command log of the first primary-tier node 102a are up to date. The metadata and the command log remain encrypted at the secondary-tier node 102c because the secondary-tier node 102c is a follower node that does not use the metadata and does not commit changes to data based on transaction commands in the command log. As such, after synchronization, the metadata and command log are decrypted at the first primary-tier node 102a. In addition, after the first primary-tier node 102a becomes the leader, it replays the unencrypted transaction commands from the command log. This is done to create the most recent activity at the first primary-tier node 102a based on the transaction commands in the command log. The instructions and/or operations 800 end.

FIG. 9 is a block diagram of an example programmable circuitry platform 900 structured to execute and/or instantiate the example machine-readable instructions and/or the example operations of FIGS. 7 and 8 to implement the node controller 600 of FIG. 6. The programmable circuitry platform 900 can be, for example, a server, a personal computer, a workstation, a self-learning machine (e.g., a neural network), or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, XPUs, and/or microcontrollers from any desired family or manufacturer. The programmable circuitry 912 may be implemented by one or more semiconductor based (e.g., silicon based) devices. In this example, the programmable circuitry 912 implements the timer 604, the redundancy manager 606, and the quorum manager 608 of FIG. 6.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 920 implements the interface 602 of FIG. 6.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices, optical storage devices, RAID systems, and/or solid-state storage discs or devices such as flash memory devices and/or SSDs.

The machine-readable instructions 932, which may be implemented by the machine-readable instructions of FIGS. 7 and 8, may be stored in the mass storage device 928, in the volatile memory 914, in the non-volatile memory 916, and/or on at least one non-transitory computer readable storage medium which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 and/or components thereof may include additional and/or alternate structures to those shown and described below. The microprocessor 1000 is a semiconductor device fabricated to include transistors interconnected to implement the structures described below in one or more integrated circuits (ICs) contained in one or more packages.

The microprocessor 1000 executes machine-readable instructions of the flowcharts of FIGS. 7 and 8 to instantiate the circuitry of FIG. 6 as logic circuits to perform operations corresponding to those machine-readable instructions. In some such examples, the circuitry of FIG. 6 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including M cores. The cores 1002 of the microprocessor 1000 may operate independently or may cooperate to execute machine-readable instructions. For example, machine code corresponding to a firmware program, an embedded software program, or a software program represented by the flowcharts of FIGS. 7 and 8 may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 7 and 8.

The cores 1002 may communicate by a first example bus 1004. For example, the first bus 1004 may be implemented by any suitable bus technology (e.g., an Inter-Integrated Circuit (I2C) bus, a Serial Peripheral Interface (SPI) bus, a PCI bus, a PCIe bus etc.). Data, instructions, and/or signals may be communicated (e.g., accessed, obtained, output, provided, etc.) between the cores 1002 and one or more external devices by example interface circuitry 1006. Although the cores 1002 of this example include example local cache 1020 (e.g., Level 1 (L1) cache that may be split into an L1 data cache and an L1 instruction cache), the microprocessor 1000 also includes example shared cache 1010. The shared cache 1010 is shared by the cores (e.g., Level 2 (L2 cache)) to access data and/or instructions across the cores.

Each core 1002 includes control unit circuitry 1014, arithmetic and logic (AL) circuitry (sometimes referred to as an arithmetic logic unit (ALU)) 1016, a plurality of registers 1018 (e.g., hardware registers), the local cache 1020, and a second example bus 1022. The control unit circuitry 1014 controls (e.g., coordinates) data movement within the corresponding core 1002. The AL circuitry 1016 performs one or more mathematic and/or logic operations on the data within the corresponding core 1002.

The registers 1018 store data and/or instructions such as results of operations performed by the AL circuitry 1016. The second bus 1022 may be implemented using any suitable bus technology (e.g., an I2C bus, a SPI bus, a PCI bus, or a PCIe bus, etc.).

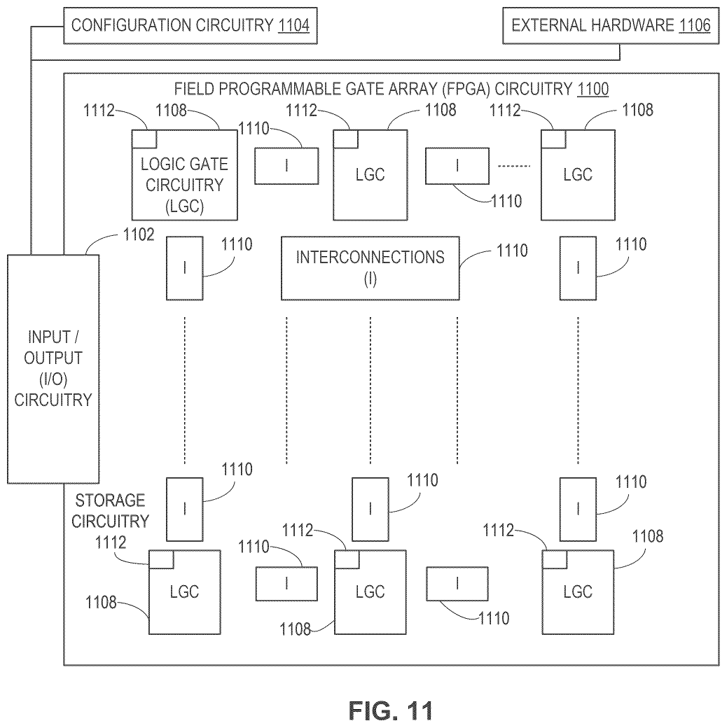

FIG. 11 is a block diagram of another example implementation of the programmable circuitry 912 of FIG. 9. In this example, the programmable circuitry 912 is implemented by FPGA circuitry 1100. Programmable logic circuitry of the FPGA circuitry 1100 may be programmed to create dedicated logic circuits that perform operations and/or functions represented in the flowcharts of FIGS. 7 and 8. For example, the FPGA circuitry 1100 includes interconnections and logic circuitry (e.g., logic gates, switches, etc.) that may be configured, structured, programmed, and/or interconnected in different ways to instantiate some or all of the operations/functions corresponding to the machine-readable instructions represented by the flowcharts of FIGS. 7 and 8. After an FPGA programming process, the FPGA circuitry 1100 instantiates the operations and/or functions corresponding to the machine-readable instructions in hardware. In some examples, the FPGA circuitry 1100 can execute the operations/functions faster than they could be performed by a general-purpose microprocessor.

The FPGA circuitry 1100 of FIG. 11, includes example input/output (I/O) circuitry 1102 to obtain data from and/or output data to example configuration circuitry 1104 and/or external hardware 1106 (e.g., microprocessor circuitry, controller circuitry, memory circuitry, storage circuitry, a computer, etc.). For example, the configuration circuitry 1104 may be implemented by interface circuitry that obtains a binary file to program or configure the FPGA circuitry 1100.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to machine-readable instructions of FIGS. 7 and 8 and/or other desired operations.

The storage circuitry 1112 is structured to store result(s) of operations performed by corresponding logic gates. The storage circuitry 1112 may be implemented by registers or the like.

Although not shown, the example FPGA circuitry 1100 of FIG. 11 also includes example dedicated operations circuitry to implement functions without programming those functions in the logic gate circuitry 1108. The FPGA circuitry 1100 may also include general purpose programmable circuitry such as a CPU, a DSP, etc.

Although FIGS. 10 and 11 illustrate two example implementations of the programmable circuitry 912 of FIG. 9, many other approaches are contemplated. For example, a hybrid circuitry example may include one or more cores 1002 of FIG. 10 that execute(s) a first portion of the machine-readable instructions represented by the flowcharts of FIGS. 7 and 8 to perform first operation(s)/function(s), and/or include the FPGA circuitry 1100 of FIG. 11 configured and/or structured to perform second operation(s)/function(s) corresponding to a second portion of the machine-readable instructions represented by the flowcharts of FIGS. 7 and 8, and/or include an ASIC configured and/or structured to perform third operation(s)/function(s) corresponding to a third portion of the machine-readable instructions represented by the flowcharts of FIGS. 7 and 8.

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In some examples, the programmable circuitry 912 of FIG. 9 may be in one or more packages. For example, the microprocessor 1000 of FIG. 10 and/or the FPGA circuitry 1100 of FIG. 11 may be in one or more packages.

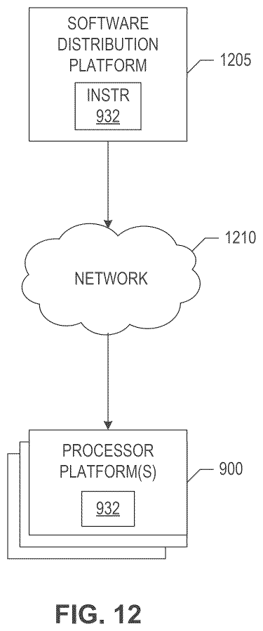

A block diagram illustrating an example software distribution platform 1205 to distribute software such as the example machine-readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. In the illustrated example, the software distribution platform 1205 includes one or more servers and one or more storage devices. The storage devices store the machine-readable instructions 932, which may correspond to the example machine-readable instructions of FIGS. 7 and 8, as described above. The one or more servers of the example software distribution platform 1205 are in communication with an example network 1210, which may correspond to any one or more of the Internet and/or any of the example networks described above. The servers enable downloading the machine-readable instructions 932 from the software distribution platform 1205. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include any circuitry that can be programmed or configured to perform different operations and that includes one or more semiconductor-based logic devices (e.g., electrical hardware implemented by one or more transistors. Programmable circuitry may be: (i) one or more special purpose electrical circuits (e.g., an ASIC) and/or (ii) one or more general purpose semiconductor-based electrical circuits programmable with instructions. Examples of programmable circuitry include programmable microprocessors such as CPUs, FPGAs, GPUs, DSPs, XPUs, Network Processing Units (NPUs), and/or integrated circuits such as ASICs. For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing tasks to whichever one(s) of the multiple types of programmable circuitry is/are suited and available to perform the computing tasks.

From the foregoing, it will be appreciated that example systems, apparatus, articles of manufacture, and methods have been disclosed that implement heterogenous quorum-based systems. Disclosed systems, apparatus, articles of manufacture, and methods improve the efficiency of using a computing device by improving node-failure tolerance in a computing cluster so that the cluster can maintain a leader node and continue providing services to customers even when one or more nodes of the cluster fail(s). Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A first node in a first data center, the first node comprising:
interface circuitry to transmit an advertisement from the first node to a second node in a second data center and a third node in a cloud system, the advertisement to specify a leader-candidate status for the first node;
machine-readable instructions; and
at least one processor circuit to be programmed by the machine-readable instructions to:
execute a first application at the first node, wherein the first application is redundant of a second application executed at the second node, the first application to provide redundancy and failover operation to tolerate unavailability of the second application at the second node;
cause storing of metadata in an unencrypted state at the first node, the metadata being a copy of redundant metadata stored in an unencrypted state at the second node in the second data center and stored in an encrypted state at the third node in the cloud system;
after unavailability of the second node, access votes from the first node in the first data center and the third node in the cloud system;
after the votes satisfy a quorum to elect the first node as a leader node, set a role of the first node as the leader node;
synchronize the metadata from the encrypted state at the third node to the unencrypted state at the first node; and
reconstruct data at the first data center based on the metadata at the first node.

2. (canceled)

3. (canceled)

4. The first node of claim 1, wherein the first data center stores the data corresponding to the first node, the data being a copy of redundant data in the second data center, the redundant data not stored in the cloud system corresponding to the third node.

5. The first node of claim 1, wherein:
the interface circuitry is to:
receive a second advertisement specifying a leader-candidate status for the second node in the second data center; and
transmit, to the second node, a vote for the second node to serve as the leader node; and
one or more of the at least one processor circuit is to set the role of the first node as a follower node.

6. The first node of claim 5, wherein, after the unavailability of the second node at the second data center, one or more of the at least one processor circuit is to change the role of the first node from the follower node to the leader node.

7. The first node of claim 1, wherein a first network connection between the first node and the second node is a lower latency and higher bandwidth connection than a second network connection between the first node and the third node.

8. The first node of claim 1, wherein the first node and the second node are instantiated on dedicated hardware in corresponding ones of the first data center and the second data center, and the third node is instantiated on cloud resources in the cloud system.

9. At least one non-transitory machine-readable medium comprising machine-readable instructions to cause a first node to at least:
cause transmission of an advertisement from the first node in a first availability zone to a second node in a second availability zone and a third node in a third availability zone, the advertisement to specify a leader-candidate status for the first node, the first node and the second node eligible to vote for a leader and eligible to serve as a leader node, the third node eligible to vote for the leader and ineligible to serve as the leader node;
execute a first application at the first node, wherein the first application is redundant of a second application executed at the second node, the first application to provide redundancy and failover operation to tolerate unavailability of the second application at the second node;
cause storing of metadata in an unencrypted state at the first node, the metadata being a copy of redundant metadata stored in an unencrypted state at the second node and stored in an encrypted state at the third node;
after unavailability of the second node, access votes from the first node in the first availability zone and the third node in the third availability zone;
after the votes satisfy a quorum to elect the first node as the leader node, set a role of the first node as the leader node;
synchronize the metadata from the encrypted state at the third node to the unencrypted state at the first node; and
reconstruct data at the first availability zone based on the metadata at the first node.

10. The at least one non-transitory machine-readable medium of claim 9, wherein the first availability zone is a first data center, the second availability zone is a second data center, the third availability zone is a cloud system.

11. The at least one non-transitory machine-readable medium of claim 9, wherein the first availability zone is a first failure domain in a first data center, the second availability zone is a second failure domain in the first data center, the third availability zone is a third failure domain in a second data center.

12. The at least one non-transitory machine-readable medium of claim 9, wherein the machine-readable instructions are to cause the first node to synchronize an encrypted command log from the third node to the first node.

13. The at least one non-transitory machine-readable medium of claim 9, wherein the machine-readable instructions are to cause the first node to:
access a second advertisement specifying a leader-candidate status for the second node in the second availability zone;
cause transmission of a vote for the second node to serve as the leader node; and
set the role of the first node as a follower node.

14. The at least one non-transitory machine-readable medium of claim 13, wherein, after the unavailability of the second node at the second availability zone, the machine-readable instructions are to cause the first node to change the role of the first node from the follower node to the leader node.

15. The at least one non-transitory machine-readable medium of claim 9, wherein a first network connection between the first node and the second node is a lower latency and higher bandwidth connection than a second network connection between the first node and the third node.

16. A method comprising:
causing, by at least one processor circuit programmed by at least one instruction, transmission of an advertisement from a first node in a first availability zone to a second node in a second availability zone and a third node in a third availability zone, the advertisement to specify a leader-candidate status for the first node, the first node and the second node eligible to vote for a leader and eligible to serve as a leader node, the third node eligible to vote for the leader and ineligible to serve as the leader node;
executing a first application at the first node, wherein the first application is redundant of a second application executed at the second node, the first application to provide redundancy and failover operation to tolerate unavailability of the second application at the second node;
causing, by one or more of the at least one processor circuit, storing of metadata in an unencrypted state at the first node, the metadata being a copy of redundant metadata stored in an unencrypted state at the second node and stored in an encrypted state at the third node;
after unavailability of the second node, accessing votes from the first node in the first availability zone and the third node in the third availability zone;
after the votes satisfy a quorum to elect the first node as the leader node, setting a role of the first node as the leader node;
synchronizing the metadata from the encrypted state at the third node to the unencrypted state at the first node; and
reconstructing data at the first availability zone based on the metadata at the first node.

17. The method of claim 16, wherein the first availability zone is a first data center, the second availability zone is a second data center, the third availability zone is a cloud system.

18. The method of claim 16, wherein the first availability zone is a first failure domain in a data center, the second availability zone is a second failure domain in the data center, the third availability zone is a third failure domain in the data center.

19. The method of claim 16, comprising synchronizing an encrypted command log from the third node to the first node.

20. The method of claim 16, comprising:
accessing a second advertisement specifying a leader-candidate status for the second node in the second availability zone;
transmitting, to the second node, a vote for the second node to serve as the leader node; and
setting the role of the first node as a follower node.
